(19) United States
(12) Patent Application Publication
(10) Pub. No.: US 2010/0321659 A1
(43) Pub. Date: Dec. 23, 2010

(54) Illumination Arrangement

(76) Inventor: Matthias Kock, Wentorf (DE)

Correspondence Address: NOTARO, MICHALOS & ZACCARIA P.C., 100 DUTCH HILL ROAD, ORANGEBURG, NY, 10962, US

(21) Appl. No.: 12/446,105

(22) PCT Filed: Sep. 27, 2007
(86) PCT No.: PCT/EP2007/008344

§ 371 Date: Jun. 9, 2009

(30) Foreign Application Priority Data
Oct. 18, 2006 (DE) 10 2006 049 169.6

(51) Int. Cl. G03B 27/54; G02B 26/00; F21V 8/00

(52) U.S. Cl. 355/67; 359/292; 362/553

(57) ABSTRACT

Illumination arrangement (3) for lighting a reflective light modulator (4) under oblique light incidence, comprising, one after another along an optical axis (10), a light source (6) with a first axis (19) and a second axis (18), wherein the second axis (18) is arranged at right angles to the first axis (19) and a dimension of the light source (6) in the direction of the first axis (19) is preferably smaller than a dimension of the light source (6) in the direction of the second axis (18), a homogenizer (9) for coupling in the light radiation emitted by the light source (6) having an entrance face (8) and an exit face (11) and an illumination optics (12) for imaging the exit face (11) of the homogenizer (9) onto a light modulator (4) while maintaining the efficiency in such a way that homogeneous lighting of the light modulator can be achieved, wherein it is proposed that the light source (6) is arranged such that it is offset with respect to the homogenizer (9) transversely to the optical axis (10) or that an emission direction (28) of the light source (6) opposite a surface normal (29) of the entrance face (8) of the homogenizer (9) is arranged at an angle (30).

The present invention relates to an illumination arrangement for the illumination of a reflective light modulator under oblique light incidence, comprising sequentially along an optical axis a light source with a first and a second axis, wherein the second axis is perpendicular to the first axis and one dimension of the light source in the direction of the first axis is preferably smaller than one dimension of the light source in the direction of the second axis, a homogenizer for coupling in the light radiation emitted by the light source with an entrance face and an exit face as well as an illumination optics for imaging the exit face of the homogenizer onto a light modulator.

The invention relates likewise to an exposure device with an illumination arrangement, a reflective light modulator illuminatable by the illumination arrangement under oblique light incidence as well as to an imaging optics for imaging the image of the light modulator onto a printing plate to be exposed.

Exposure devices of the above described type frequently comprise an illumination arrangement of the above described type.

Such illumination arrangements are utilized in connection with projection optics such as, for example, image projectors or projection television sets or also exposure devices for exposing printing plates to be exposed.

The reflective light modulator utilized in such exposure devices necessitates that the illumination arrangement as well as also the imaging optics are located on the same side of the light modulator. This leads to the necessity of separating the incident from the exiting light path. For this purpose in many applications, in particular in such in which a digital micromirror arrangement (known by the tradename DMD™) is utilized as a light modulator, a spatial separation of the light paths is carried out. However, this means that an oblique light incidence from the illumination arrangement onto the reflective light modulator of the exposure device must be chosen. Due to the geometry, this leads to distortions with the consequence of an inhomogeneous illumination level of the light modulator.

An illumination arrangement according to the species comprises a homogenizer, in which the light emitted from a light source is coupled in in order to be homogenized in the homogenizer. At the output of the homogenizer, thus, a homogenized pencil beam of rays is formed as a result of the homogenizing effect of the homogenizer. This beam of rays is imaged onto the light modulator with the aid of the illumination optics. Since the light modulator, however, is located at an angle with respect to the optical axis, necessary for the beam separation, of the illumination arrangement, as a result, for reasons of geometry, an inhomogeneous illumination level is generated on the light modulator. Due to the oblique incidence, an originally square cross sectional area of the illumination beam receives the form of a convex rectangle on the light modulator. This inhomogeneity, however, is not acceptable for the application.

For this reason various measures have been taken in prior art in order to compensate the inhomogeneous illumination of the light modulator. This is required, for example, in order to attain a qualitatively high-grade exposure of the printing plates. It is likewise necessary for video projection applications to compensate a nonuniform disposition of the light modulator in order to be able to generate uniform projection images.

EP 1 141 780 B1, for example, discloses an exposure device of the above described type with an illumination device of the above described type. In the known exposure device a complex system of a field lens, through which passes the incident as well as also the exiting light of the light modulator, serves for the beam conformation. According to prior art, the beam cross sections of the ray beam, incident and reflected on the micromirror arrangement, are shaped in the form of an oval, wherein their longer transverse dimension is substantially disposed perpendicularly to the plane spanned of the direction of incidence and exit. To correct the oblique light incidence onto the micromirror arrangement, prior art proposes that in the beam path a prism is disposed between a condenser and the micromirror arrangement. However, this approach is of disadvantage since for the compensation of the inhomogeneity an additional optical element is required which leads to losses and undesirably increases the material and adjustment costs.

EP 1 212 198 B1 also discloses an exposure device according to the species with an illumination arrangement according to the species. In this exposure device according to prior art, for the compensation of the inhomogeneous illumination of the micromirror arrangement serving as light modulator it is proposed that the modulation pattern, which is impressed onto the light modulator, is previously electronically compensated with the illumination intensity at the site of the light modulator by calculation. Thus, in this prior art a superposition of the exposure data with the surface intensity distribution on the face of the light modulator is carried out. This process is also referred to as overlay technique.

However, of disadvantage herein is primarily that in the overlay method a homogenization of the exit ray beam is ultimately attained thereby that all picture elements are brought to the intensity level of that picture element at which the lowest illumination intensity obtains. In the case of the micromirror arrangements as light modulator, this means that pixels at better illuminated picture elements remain switched off longer than corresponds to the actual image information. This takes place thereby that the corresponding micromirror is tilted such that the impinging light is reflected away from the exiting ray beam. The overlay method thus leads to the consequence that the most poorly illuminated picture element determines the maximal intensity of all picture elements. With this prior art, a system is obtained with disadvantageously comparatively low efficiency independently of whether or not the optics and the optical elements for the remainder have been selected to be optimized.

The present invention therefore addresses the problem of improving an illumination arrangement of the above described type, as well as an exposure device with an illumination arrangement according to the species, to the effect that compensation of inhomogeneities in the illumination of the light modulator can be attained without the reduction of efficiency.

This problem is resolved according to the invention in an illumination arrangement according to the species in that the light source with respect to the homogenizer is displaced transversely to the optical axis. The invention thus proposes that the light source is not disposed, relative to the optical axis, centrally in front of the homogenizer. Instead, an eccentric off-centered orientation is intentionally selected. Hereby is attained that at the output of the homogenizer an obliquely extending intensity profile is formed.

With suitable selection of the displacement of the light source with respect to the homogenizer, it is possible to attain according to the invention that, due to the oblique intensity profile at the homogenizer output, the distortion of the incident beam profile, due to the oblique incidence of the illumination beam onto the light modulator, is precisely compensated. Herein, however, in contrast to prior art, the compensation according to the invention in principle takes place without any efficiency loss. No radiative energy is lost through the compensation process according to the invention. Moreover, no additional optics are required, which is especially cost-effective.

Instead, with the components available in prior art through an intentional dejustification the compensation becomes possible in simple manner without efficiency reduction.

In the implementation of the invention it is especially advantageous if the light source is displaced in the direction of the second axis. This second axis can be, for example when using a laser, the slow axis. In light sources which are comprised of a laser diode row, as the slow axis is denoted the direction of the greater dimension, thus the width of the laser diode row.

In an alternative implementation of the illumination arrangement according to the invention, in contrast, the light source is displaced in the direction of the first axis. This can be, for example when using a laser, the fast axis. In an illumination arrangement with a laser diode row as the light source, as the fast axis is denoted the height direction of the row, thus the direction which, in comparison to a width, has the smaller dimension.

A further advantageous implementation of the illumination arrangement according to the invention provides that the light source has in the direction of the first and of the second axis a lesser dimension than the homogenizer, wherein the light source and the homogenizer are oriented relative to one another such that a cross sectional area of the light source through perpendicular projection in the direction of the optical axis can be imaged completely on the cross sectional area of the homogenizer. This disposition ensures that no light radiation is lost by being quasi guided past the entrance face of the homogenizer and subsequently would be lost for the illumination light path. Off-centered displacement of the light source relative to the entrance face of the homogenizer takes place according to this implementation of the invention only within the limits given by the dimension of the entrance face of the homogenizer.

The homogenization of the light radiation emitted by the light source in further advantageous implementation of the invention is especially effectively attained if the homogenizer is formed as an integrator rod. Through multiple total reflection on the inner surfaces of the integrator rod, a highly effective thorough mixing can be attained of the entrance beam directions at the exit face of the homogenizer. With suitable selection of the homogenizer material as well as appropriate coating of the entrance and exit faces of the homogenizer, the homogenization can, furthermore, with the integrator rod according to the invention, also be attained with especially low intensity losses.

In another advantageous implementation of the illumination arrangement according to the invention the homogenizer is formed as a light tunnel. The principle of homogenization through a light tunnel corresponds to that which forms the basis in the integrator rod. However, in contrast to the integrator rod, in the case of the light tunnel the radiation is guided by the hollow volume delimited by the light tunnel. This has the particular advantage that neither in the interior of the light tunnel a radiation absorption occurs nor are reflection losses generated at the entrance face since no media transition is present at the entrance face.

According to the invention the homogenization is formed especially effective if the homogenizer has a rectangular cross sectional area.

In this connection it is preferred according to the invention if an aspect ratio of the cross sectional area is adapted to the light modulator. Through the adaptation of the aspect ratio of the cross sectional area of the exit face of the light modulator to the light modulator, through suitable illumination optics, the exit face of the homogenizer can be projected onto the active face of the light modulator without spillover loss due to the geometry. It is thus avoided that a portion of the light is guided past the light modulator.

In a preferred implementation of the illumination arrangement according to the invention the light source includes at least one laser diode module with an optical fiber for coupling in the light radiation emitted by the laser diode module. Due to their narrow emission spectrum and the high light yield entailed therein, for exposure applications laser diode modules are especially suitable for attaining high efficiency of an exposure device. The small area-solid angle product (étendue) of a laser diode module is advantageous for an especially efficient illumination arrangement. Lastly, several laser diode modules with one optical fiber each can advantageously be joined in series into a laser diode module row in order to obtain a higher intensity of the emitted light radiation.

The problem forming the basis of the invention is likewise solved through an illumination arrangement according to the species in which the emission direction of the light source is disposed at an angle with respect to a surface normal of the entrance face of the homogenizer. Through this measure it is attained that the light emitted by the light source impinges obliquely onto the entrance face of the homogenizer. For reasons of geometry, this causes a distortion of the intensity profile of the light source, which originally was substantially homogeneous, in all planes extending parallel to the entrance face of the homogenizer. As a result, the intensity profile of the light is also inhomogeneous at the exit face of the homogenizer. This inhomogeneity at the exit face of the homogenizer, intentionally brought about by the disposition according to the invention of the light source at an angle with respect to the entrance face, leads to the fact that the light modulator, which itself is disposed at an angle to the exit face of the homogenizer, with suitable layout of the angle between light source and entrance face of the homogenizer is illuminated homogeneously. This homogeneous illumination is attained according to the invention without losses due to the principle involved.

The flexibility in the generation of desired exit intensity profiles becomes in an implementation of the invention especially great if the illumination arrangement according to the variant of the invention is additionally implemented according to one of the above described embodiments.

The combination of a transverse displacement with an angular disposition of light source and homogenizer advantageously leads to an optimized formation of the exit intensity at the exit face of the homogenizer.

The problem addressed by the present invention is, furthermore, solved through an exposure device of the above described type, in which the illumination arrangement is implemented according to the one of the above described embodiments.

The illumination generated by an illumination arrangement according to the invention with oblique intensity profile, with suitable adjusting of the intensity profile curve serves for the complete compensation of the inhomogeneity resulting from the oblique light incidence onto the light modulator due to geometric distortion. Consequently, according to the invention, as a result a highly homogeneous illumination of the light modulator is obtained without lowering the efficiency of the exposure device for this purpose. For the compensation of the geometrically caused inhomogeneity through the oblique incidence, further, neither additional data processing steps, for example for the calculation of an overlay image, are required nor are additional elements, such as for example a prism, necessary.

In a preferred embodiment of the exposure device according to the invention, the light modulator is formed as a microelectro-mechanical system (MEMS), preferably a digital micromirror device (DMD™). Due to the fast response times of the individual minors and the by now available high resolutions of these minor matrices, especially DMDs have become a widely established technique for the light modulator. In contrast to light modulators based on liquid crystals, DMDs and other MEMSs have the advantage that a modulation of the incident light is possible independently of its polarization. Losses through preceding polarizers, such as are in principle required in liquid crystal-based systems, can therefore be advantageously omitted. The current generation of DMD chips is distinguished by an increased tilt angle of 12°. This has the advantage, on the one hand, that a simpler spatial separation of the incident from the exiting beam is possible. However, on the other hand, the geometric distortion of the entrance beam generated by the illumination arrangement onto the DMD is increased. However, according to the invention this can be compensated without encountering problems and cost-effectively through the use of the illumination arrangement according to the invention.

The invention will be described by example in a preferred embodiment with reference to a drawing, wherein further advantageous details are evident in the figures of the drawing.

Functionally identical parts are provided with the same reference numbers.

The Figures of the drawing depict in detail:

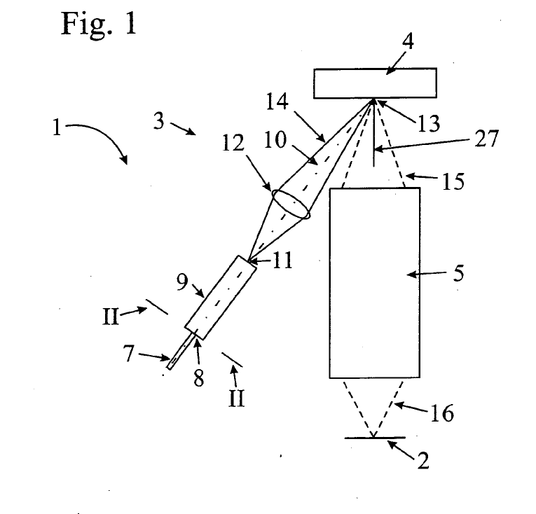

FIG. 1: schematic representation of an exposure device according to the invention with an illumination arrangement according to the invention,

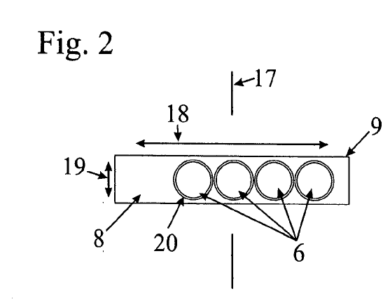

FIG. 2: a detail representation of the illumination arrangement from FIG. 1 to illustrate the relative position of the light source with respect to the detail indicator entrance face in a sectional view along line II-II in FIG. 1,

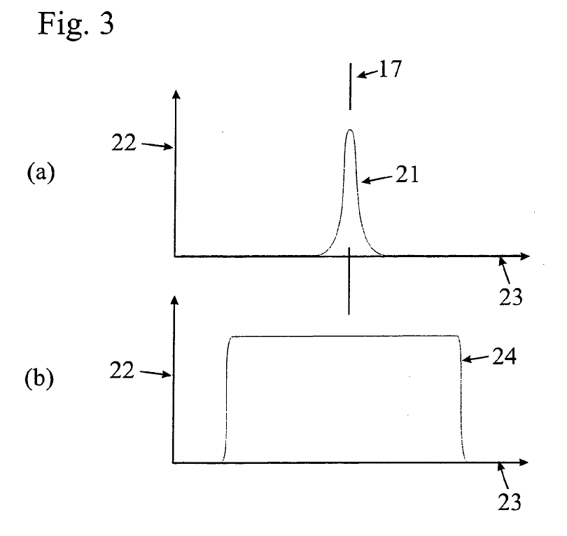

FIG. 3: spatial intensity distribution in the direction of the slow axis of the light source at the entrance (a) and exit face (b) of the homogenizer in a conventional arrangement according to prior art,

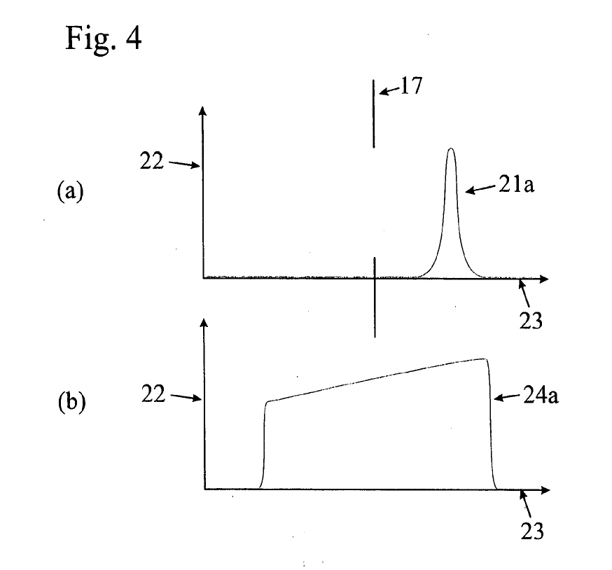

FIG. 4: spatial intensity distribution in the direction of the slow axis of the light source at the entrance (a) and exit face (b) of the homogenizer in an illumination arrangement according to the invention,

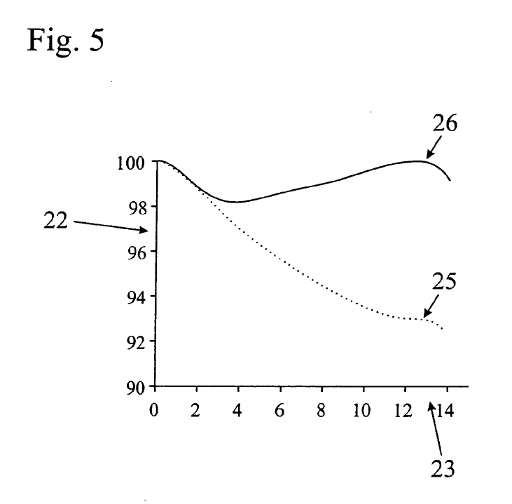

FIG. 5: Spatial intensity distribution at the light modulator for the illumination according to FIG. 4 (invention) and for comparison FIG. 3 (prior art),

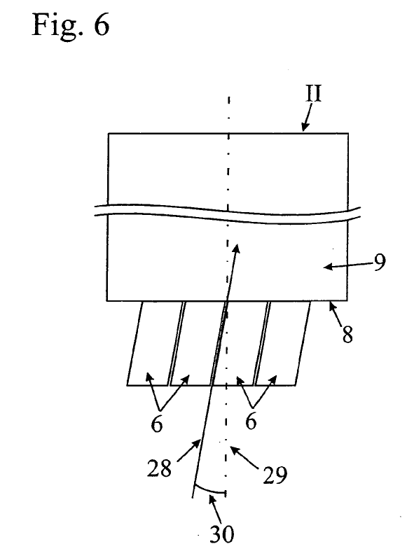

FIG. 6: a detail representation of a variant according to the invention of the illumination arrangement of FIG. 1 to illustrate the relative position of the light source to the detail indicator entrance face, wherein the perspective corresponds to that shown in FIG. 1,

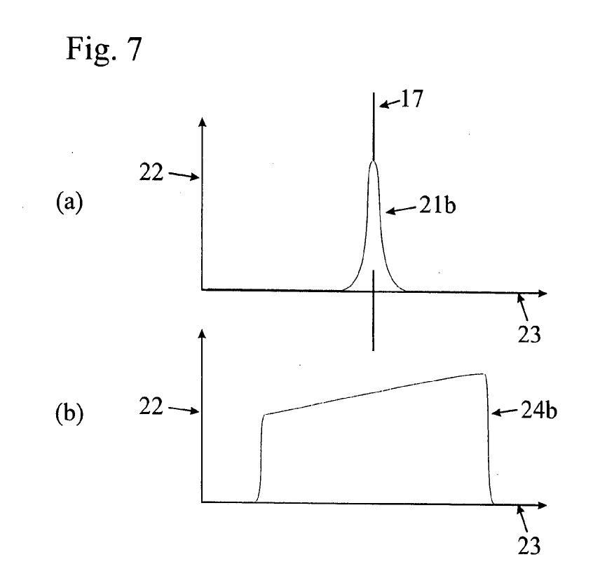

FIG. 7: spatial intensity distribution in the direction of the slow axis of the light source at the entrance (a) and exit face (b) of the homogenizer in an illumination arrangement according to an alternative of the invention.

FIG. 1 shows schematically an exposure device 1 for exposing a printing plate 2. The exposure device 1 is substantially comprised of an illumination optics 3, a light modulator 4 as well as an imaging optics 5. The illumination optics 3 comprises a (not shown) laser diode module row. In the laser diode module row a fiber is associated with each individual laser diode, into which fiber the light emitted by the individual laser diode is coupled. The discrete fibers 6 are combined into a fiber bundle 7. The fiber bundle 7 is directed onto an entrance face 8 of an integrator rod 9. The entrance face 8 appears as a line in the schematic top view of FIG. 1.

The illumination optics 3 has an optical axis 10 depicted schematically in FIG. 1 as a dot-dash line. The integrator rod 9 has an exit face 11. The exit face 11 of the integrator rod 9 appears again as a line in the schematic top view from FIG. 1. In the direction of the optical axis 10, succeeding the integrator rod 9 in the exit face 11a lens 12 is disposed. At an angle to the optical axis of the illumination optics 3 of the exposure device 1 is disposed a digital micromirror device DMD™ 4. The DMD 4 includes an active minor matrix (not shown in the top view of FIG. 1), which is disposed in an active modulation plane 13. The modulation plane 13 appears in the FIG. 1, which is conceptualized as a top view, also only as a line. In the direction of the light path the DMD 4 is adjoined by the imaging optics 5, which is disposed opposite the printing plate 2.

Evident in FIG. 1 is further an entrance ray beam 14 as well as an exit ray beam 15. The entrance ray beam 14 in the Figure is incident from the left onto the DMD 4 and after reflection leaves the modulation plane 13 of the DMD 4 in the form of the exit ray beam 15. FIG. 1, lastly, shows an exposure ray beam 16. The exposure ray beam 16 extends from the imaging optics 5 onto the printing plate 2.

FIG. 2 is a side view in the direction of the optical axis 10 of the illumination optics 3. Evident is a sectional representation along line II-II of FIG. 1, which includes the entrance face 8 of the integrator rod 9. As is evident in FIG. 2, the discrete fibers 6 of the fiber bundle 7 are disposed one next to the other in a row. The Figure shows overall four discrete fibers 6. A center line of the entrance face 8 of the integrator rod 9 is denoted in FIG. 2 by the reference number 17. The totality of the five discrete fibers 6 of the fiber bundle 7 has a slow axis 18 and a fast axis 19. The slow axis 18 extends parallel to a width of the totality of the discrete fibers 6, whereas the fast axis 19 extends parallel to a height of the totality of the discrete fibers 6. Each discrete fiber 6 has a cladding 20.

As can be seen in FIG. 2 one discrete fiber 6, as depicted in the representation according to FIG. 2, is located substantially to the left of the center line 17 of the entrance face 8 of the integrator rod 9, whereas two of the discrete fibers 6 are substantially to the right of the center line 17 of the entrance face 8 of the integrator rod 9. The light source of the totality of the discrete fibers 6 is thus oriented off-centered to the entrance face 8 of the integrator rod 9. The off-centered orientation according to the perspective shown in FIG. 2 refers to a direction transversely to the optical axis 10 of the illumination optics 3. Stated more precisely, the light source formed of the totality of the discrete fibers 6 is displaced in the direction of the slow axis 18 relative to the center line 17 of the entrance face 8 of integrator rod 9.

The integrator rod 9 is 6 mm wide. The diameter of each discrete fiber 6 is 1.0 mm, wherein, deducting the cladding 20, the active diameter of the fibers 6 is 0.9 mm. For clarification, in FIG. 2 the off-centered orientation is especially pronounced. In practice, with the stated dimensions of the integrator and the discrete fibers transverse displacements of approximately 0.6 mm have been found to be advantageous.

During operation of the exposure device, the light emitted by the laser diodes (not shown in FIG. 1 is coupled into the discrete fibers connected to form the fiber bundle 7. At the output end of the fiber bundle 7 the discrete fibers 6 are disposed as in FIG. 2 one next to the other such that the light conducted in them is incident out of the discrete fibers 6 onto the entrance face 8 of integrator rod 9.

The radiation arrives subsequently in the integrator rod 9 and is here multiply reflected on the inner walls of integrator rod 9 and is in this manner homogenized. In the entrance face 8 of the integrator rod 9 the light radiation emitted by the fiber bundle 7 has a narrow entrance intensity distribution 21, as is shown schematically in FIG. 3a. The diagram according to FIG. 3a shows at the intensity axis 22 a relative intensity of the light radiation and in the horizontal axis 23 a local coordinate parallel to the slow axis 18. On this local axis 23 is schematically drawn the center line 17 of the entrance face 8 of the integrator rod 9. The center line 17 should more precisely only appear on the one-dimensional local axis 23 as a point, since in the intensity diagram according to FIG. 3a and FIG. 4a the vertical axis represents the intensity and not a local coordinate.

The intensity distribution shown in FIG. 3a corresponds to that in a conventional illumination optics 3. In this conventional illumination optics, in contrast to the arrangement shown in FIG. 2, a central orientation is provided of the light source relative to the center line 17 of entrance face 8 of integrator rod 9. This leads to the conventional intensity distribution shown in FIG. 3a, which is disposed symmetrically about the center line 17.

In contrast, the off-centered orientation of the light source relative to the center line 17 of the entrance face 8 of the integrator rod 9 shown in FIG. 2 leads to the entrance intensity distribution 21a shown in FIG. 4a on the entrance face 8 of the integrator rod 9 in the direction of the slow axis 18. As is evident in FIG. 4a, the entrance intensity distribution 21a with respect to the center line 16 is displaced toward the right and not at all centered with the center line 17.

Depending on the selected orientation of the entrance intensity distribution 21 relative to the center line 17 of the entrance face 8 of the integrator rod 9, different exit intensity distributions 24, 24a are formed at the exit face 11 of the integrator rod 9. With the conventional orientation of the light source relative to the center line 17, which intersects the optical axis 10 of the illumination optics 3, thus, if the light source is oriented centered with respect to the entrance face 8 of the integrator rod 9, in the fast as well as also the slow axis 18, at the exit face 11 of the integrator rod 9 is obtained the intensity distribution 24 diagrammed in FIG. 3b. As can be seen, the intensity is distributed uniformly over the width of the exit face 11 of the exist entrance face 8 of the integrator rod 9.

In comparison, in the off-centered orientation of the light source relative to the entrance face 8 of integrator rod 9, as shown in FIG. 4a and FIG. 2, the intensity distribution 24a in the exit face 11 of integrator rod 9 is as illustrated in FIG. 4b. As is further evident in FIG. 4b, the exit intensity distribution 24a has a curve increasing obliquely from left to right.

FIG. 5 shows the intensity distribution in the modulation plane 13 of the DMD 4, wherein the depicted local axis extends in the plane of drawing according to FIG. 1. The diagram according to FIG. 5 shows for comparison the modulation intensity distribution 25 in the modulation plane 13 of the DMD 4 for the case of FIG. 3 a and b, which, as stated, refer to prior art.

The exit intensity distribution 24 obtained in prior art from the centered in-coupling of the light source into the integrator rod 9 according to FIG. 3 b leads in the modulation plane 13 in the representation in FIG. 5 to the conventional modulation intensity distribution 25. As can be seen, the geometric distortion, due to the oblique incidence of the light rays from the illumination optics 3 onto the DMD 4, thus due to the orientation of the optical axis 10 of the illumination optics 3 at an angle to a surface normal 27 to the modulation plane 13, leads to an intensity which decreases from left to right. The homogeneous exit intensity distribution 24 from FIG. 3 b in prior art is thus distorted into the inhomogeneous intensity distribution 25 strongly decreasing from left to right.

In comparison, in an illumination of the DMD 4 under oblique light incidence onto the modulation plane 13 of the DMD 4 with an illumination optics 3 according to the invention, which has the exit intensity distribution 24 a according to FIG. 4 b, results a modulation intensity distribution 26 in the modulation plane 13. The modulation intensity distribution 26 according to the invention, in contrast to the modulation intensity distribution 25 in prior art, is nearly homogeneous over the local axis 23.

In FIG. 6 is evident a detail representation of an alternative embodiment of an illumination arrangement 3. The general layout of this variant of the illumination optics 3 according to the invention corresponds to the layout diagrammed in FIG. 1. In contrast to the disposition of the light source, described above in the detail representation of FIG. 2, relative to the entrance face 8 of the integrator rod 9, the relative disposition according to this variant of the invention has been selected as follows:

The discrete fibers 6 of the fiber bundle 7 are so oriented that an emission direction 28 does not extend parallel to a surface normal 29 of the entrance face 8 of the integrator rod 9, but rather is oriented at an angle 30 to this surface normal. Through this disposition results the spatial intensity distribution diagrammed in FIG. 7 in the direction of the slow axis of the light source at the entrance or exit face of the integrator rod. The angle 30 in a preferred embodiment of the invention can be less than approximately 1°.

The representation of FIG. 7 corresponds in principle to the representations of FIGS. 3 and 4. FIG. 7a shows the intensity distribution at the entrance face 8 of the integrator rod. As is evident in the Figures, the entrance intensity distribution 21b at the entrance face 8 of the integrator rod 9 corresponds in terms of contour to that which is also obtained in the illumination according to prior art. The entrance intensity distribution 21b according to FIG. 7a is, in particular, symmetric to the center line 17 of the entrance face 18 of the integrator rod 9. The light source according to this alternative embodiment of the invention, however, is not displaced transversely with respect to the integrator rod 9.

In comparison, at the exit face 11 of the integrator rod 9 is obtained the intensity distribution 24b depicted in FIG. 7b. As can be seen, the exit intensity distribution 24b, which is obtained with the angular orientation, diagrammed in FIG. 6, of the light source relative to the entrance face 8 of integrator rod 9, is thus asymmetric. The exit intensity distribution 24b is consequently, as desired, inhomogeneous. Due to the inhomogeneity, the exit intensity distribution 24b is suitable to illuminate the DMD 4 under an oblique incidence onto the DMD 4.

It is further possible within the scope of the invention to combine the dispositions according to FIGS. 2 (transverse displacement) and 6 (angular position) in order to obtain suitable exit intensity distributions 24, 24a, 24b. This is not explicitly shown in the Figures.

According to the invention, thus an illumination arrangement 3 as well as an exposure device has been proposed, in which, in spite of oblique light incidence onto the light modulator, a homogeneous intensity distribution on the modulation plane 13 of the light modulator 4 can be generated at high efficiency.

The exposure device according to the invention with the illumination arrangement according to the invention can, in particular, be utilized for the exposure of conventional offset plates or other photosensitive materials.

Typical exposure wavelengths are between 350 and 450 nm. Further, screens for screen printing, flexographic printing plates, proof materials or steel plates for the punching pattern production can be exposed. The exposure device according to the invention for the illumination arrangement according to the invention is especially suitable for an exposure method in which, through the relative movement of the exposure unit to the material to be exposed, a large area can be exposed in its structure. The images of the display can be placed discretely one next to the other, wherein the exposure unit proceeds stepwise and exposes while halting. Alternatively, the exposure unit can move and expose continuously, wherein the image content is moved in counter motion on the display, such that on the material to be exposed a still image is being exposed. Strips thus formed can, again, be placed one next to the other through discrete steps.

### LIST OF REFERENCE NUMBER

1 Exposure
2 Printing plate
3 Illumination optics
4 Digital micromirror arrangement
5 Imaging optics
6 Discrete fiber
7 Fiber bundle
8 Entrance face
9 Integrator rod
10 Optical axis
11 Exist face
12 Lens
13 Modulation plane
14 Input ray beam
15 Output ray beam
16 Exposure ray beam
17 Center line
18 Slow axis
19 Fast axis
20 Cladding
21 Entrance intensity distribution (Prior Art)
21a Entrance intensity distribution (Invention)
21b Entrance intensity distribution (Invention Variant)
22 Intensity axis
23 Local axis
24 Exit intensity distribution (Prior Art)
24a Exit intensity distribution (Invention)
24b Exit intensity distribution (Invention Variant)
25 Modulation intensity distribution (Prior Art)
26 Modulation intensity distribution (Invention)
27 Surface normal
28 Emission direction
29 Surface normal
30 Angle

1-11. (canceled)

12. Illumination arrangement (3) for the illumination of a reflective light modulator (4) under oblique light incidence, comprising successively along an optical axis (10) a light source (6) with a first (19) and a second axis (18), wherein the second axis (18) is perpendicular to the first axis (19) and one dimension of the light source (6) in the direction of the first (19) axis is preferably smaller than a dimension of the light source (6) in the direction of the second axis (18), a homogenizer (9) for coupling in the light radiation emitted by the light source (6) with an entrance face (8) and an exit face (11) as well as an illumination optics (12) for imaging the exit face (11) of the homogenizer (9) onto a light modulator (4), wherein the light source comprises at least one laser diode module with an optical fiber (6) for coupling in the light radiation emitted by the laser diode module, wherein the light source (6) has in the direction of the second (18) and the first axis (19) a smaller dimension than the homogenizer (9), wherein the light source (6) and the homogenizer (9) are so oriented relative to one another that a cross sectional area of the light source (6) can be completely imaged by perpendicular projection in the direction of the optical axis (10) onto the homogenizer (9) on the entrance face (8) of the homogenizer (9), characterized in that the light source (6) is displaced with respect to the homogenizer (9) transversely to the optical axis (10).

13. Illumination arrangement (3) as claimed in claim 12, characterized in that the light source (6) is displaced in the direction of the second axis (18).

14. Illumination arrangement (3) as claimed in claim 12, characterized in that the light source (6) is displaced in the direction of the first axis (19).

15. Illumination arrangement (3) as claimed in claim 12, characterized in that the homogenizer (9) is formed as an integrator rod.

16. Illumination arrangement (3) as claimed in claim 12, characterized in that the homogenizer (9) is formed as a light tunnel.

17. Illumination arrangement (3) as claimed in claim 12, characterized in that the homogenizer (9) has a rectangular cross sectional area at the exit face (11).

18. Illumination arrangement (3) as claimed in claim 17, characterized in that an aspect ratio of the cross sectional area is adapted to the light modulator (4).

19. Illumination arrangement (3) according to the preamble of claim 12, characterized in that an emission direction (28) of the light source (6) is disposed at an angle (30) with respect to a surface normal (29) of the entrance face (8) of the homogenizer (9).

20. Exposure device (1) with an illumination arrangement (3), a reflective light modulator (4) illuminatable by the illumination arrangement (3) under oblique light incidence as well as an imaging optics (12) for imaging the image of the light modulator (4) on a printing plate (2) to be exposed, characterized in that the illumination arrangement (3) is formed according to claim 12.

21. Exposure device (1) as claimed in claim 20, characterized in that the light modulator (4) is formed as a microelectro-mechanical system (MEMS), preferably as a digital micromirror device (DMD™).
